(19) United States
(12) Patent Application Publication
(10) Pub. No.: US 2012/0098292 A1
(43) Pub. Date: Apr. 26, 2012

(54) Bi-fold tonneau moving center hinge

(75) Inventors: Keijo J. Huotari, Fenton, MI (US); Stephen J. Lewis, Harrison Township, MI (US); Dunno C. Junkin, Madison Heights, MI (US)

(73) Assignee: Magna International Inc., Aurora (CA)

(21) Appl. No.: 12/925,480

(22) Filed: Oct. 22, 2010

(51) Int. Cl. B60P 7/02; E05D 11/00; E05D 5/02

(52) U.S. Cl. 296/100.09; 16/382; 16/275

(57) ABSTRACT

A bi-fold hinge assembly for facilitating the more compact placement of a tonneau cover in a stowed position. The bi-fold hinge includes a first arcuate bracket and a second arcuate bracket, which are pivotable between a stowed position and a deployed position. The bi-fold hinge also includes a front base plate, where the second arcuate bracket is pivotally connected to the front base plate, and a rear base plate, where the first arcuate bracket pivotally connected to the rear base plate. The front base plate is connected to a front side rail, and the rear base plate is pivotally connected to a rear side rail. The front side rail and the rear side rail are part of a frame assembly used for supporting and controlling the movement of the tonneau cover as the tonneau cover is moved between the deployed position and the stowed position.

### FIELD OF THE INVENTION

The present invention relates to a bi-fold hinge for use with a foldable, stowable, tonneau cover, with the bi-fold hinge having an articulating center.

### BACKGROUND OF THE INVENTION

It is commonplace for various owners of vehicles such as pickup trucks to incorporate the use of a tonneau cover for providing items stored in the bed with protection from the elements. Tonneau covers are also used to provide an aesthetically pleasing appearance to a pickup truck.

There are various types of tonneau covers that are used with a pickup truck. One type Of cover is a single-piece cover made of fiberglass or other rigid material (often called a “hard” tonneau cover). These types of covers typically open through the use of hinges attached to the front of the bed in an area behind the cab of the truck. The hard tonneau cover is typically supported by air struts when in an open position. One drawback to this type of tonneau cover is that the cover typically has a limited range of motion when moving from an open position to a closed position, and vice versa, limiting the amount of items that can be stored in the bed of the truck. Also, hard tonneau covers typically have a latch which connects the cover to the tail gate for the purpose of providing additional attachment of the cover to the bed of the truck, which is necessary when the vehicle is moving because damage to the cover may occur if the cover is left open when the vehicle is moving. Because the cover typically must be secured to the tail gate during vehicle travel to prevent damage to the cover, the types of items that may be stored in the bed are limited in size to being less than the height of the bed.

Another type of tonneau cover used with pickup trucks is what is commonly referred to as a “soft” tonneau cover. A soft tonneau cover is typically made of a fabric, such as vinyl, which attaches to a frame having side rails, with the frame being attached to the side walls of the bed. The fabric is typically attached to the frame through the use of snap features, or the like. There are many different types frames used for supporting a soft tonneau cover. Some of these frames have a series of cross bows attached to the side rails of the frame which support the fabric in the middle area of the bed. This type of configuration is quite cumbersome to use because it requires the detachment of the fabric and the bows from the side rails of the frame to place items in the bed of the pickup. Also, if the item being transported in the bed of the pickup is quite large, it may not be possible to reassemble the bows and the fabric to the frame, creating the problem of stowing the fabric and the bows when they are not in use.

Attempts have been made to create a tonneau cover which is readily changeable between a stowed and a deployed position. One particular solution has been to provide a foldable frame. However, this particular design requires the fabric remain connected to the side rails of the frame, and the fabric is subjected to having discrete fold points, and may bunch up in certain areas, making it difficult to fold the tonneau cover. Furthermore, the hinges used with the foldable frame may not allow for the tonneau cover to fold properly, or fold one-hundred-eighty degrees to allow for the tonneau cover to be placed in an optimally stowed position.

Accordingly, there exists a need for an improved tonneau cover which incorporates a hinge having the ability to allow a soft tonneau cover connected to a frame to be folded substantially one-hundred-eighty degrees.

### SUMMARY OF THE INVENTION

The present invention is a bi-fold hinge assembly for facilitating the more compact placement of a tonneau cover in a stowed position. The bi-fold hinge of the present invention includes a first arcuate bracket and a second arcuate bracket. The first arcuate bracket and the second arcuate bracket are pivotable between a stowed position and a deployed position. The bi-fold hinge also includes a front base plate, where the second arcuate bracket is pivotally connected to the front base plate, and a rear base plate, where the first arcuate bracket pivotally connected to the rear base plate.

The bi-fold hinge also includes a central pivot point, the first arcuate bracket and the second arcuate bracket are pivotally connected to each other at the central pivot point such that the first arcuate bracket and the second arcuate bracket pivot relative to one another. The first arcuate bracket pivots relative to the rear base plate and the second arcuate bracket pivots relative to the front base plate. The central pivot point moves as the first arcuate bracket and the second arcuate bracket are moved between the stowed position and the deployed position.

In one embodiment, the front base plate is connected to a front side rail, and the rear base plate is pivotally connected to a rear side rail. The front side rail and the rear side rail are part of a frame assembly used for supporting and controlling the movement of the tonneau cover as the tonneau cover is moved between the deployed position and the stowed position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a frame system having a bi-fold hinge in a deployed position attached to the bed of a pickup truck, according to the present invention;

FIG. 2 is a perspective view of a frame system having a bi-fold hinge in a first partially open position attached to the bed of a pickup truck, according to the present invention;

FIG. 3 is a perspective view of a frame system having a bi-fold hinge in a second partially open position attached to the bed of a pickup truck, according to the present invention;

FIG. 4 is a perspective view of a frame system having a bi-fold hinge in a third partially open position attached to the bed of a pickup truck, according to the present invention;

FIG. 5 is a perspective view of a frame system having a bi-fold hinge in a fully stowed position attached to the bed of a pickup truck, according to the present invention;

FIG. 6 is a first perspective view of a frame system having a bi-fold hinge in deployed position, according to the present invention;

FIG. 7 is a second perspective view of a frame system having a bi-fold hinge in a fully stowed position, according to the present invention;

FIG. 8 is a first side view of a frame system having a bi-fold hinge in a first partially stowed position, according to the present invention;

FIG. 9 is a second side view of a frame system having a bi-fold hinge in a second partially open position, according to the present invention;

FIG. 10 is a side view of a frame system having a bi-fold hinge in a fully stowed position, according to the present invention;

FIG. 11 is a perspective view of a frame system having a bi-fold hinge in a fully stowed position, according to the present invention;

FIG. 12 is an enlarged perspective view of a bi-fold hinge connected to a frame system in a folded position, with the frame system removed from a pickup truck, according to the present invention;

FIG. 13 is an enlarged perspective view of a bi-fold hinge connected to a frame system in a first partially folded position, with the frame system removed from a pickup truck, according to the present invention;

FIG. 14 is an enlarged perspective view of a bi-fold hinge connected to a frame system in a second partially folded position, with the frame system removed from a pickup truck, according to the present invention;

FIG. 15 is an enlarged perspective view of a bi-fold hinge connected to a frame system in a fully deployed position, with the frame system removed from a pickup truck, according to the present invention;

FIG. 16 is a first perspective view of a frame system having a bi-fold hinge attached to the bed of a pickup truck in a deployed position, according to the present invention;

FIG. 17 is a second perspective view of a frame system having a bi-fold hinge attached to the bed of a pickup truck, according to the present invention;

FIG. 18 is a third perspective view of a frame system having a bi-fold hinge attached to the bed of a pickup truck in a deployed position, according to the present invention;

FIG. 19 is a first perspective view of a frame system having a bi-fold hinge attached to the bed of a pickup truck in a stowed position, according to the present invention;

FIG. 20 is a second perspective view of a frame system having a bi-fold hinge attached to the bed of a pickup truck in a stowed position, according to the present invention;

FIG. 21 is a third perspective view of a frame system having a bi-fold hinge attached to the bed of a pickup truck in a stowed position, according to the present invention;

FIG. 22 is an enlarged perspective view of a bi-fold hinge connected to a frame system in a partially folded position, with the frame system attached to the bed of a pickup truck, according to the present invention;

FIG. 23 is an enlarged perspective view of a bi-fold hinge connected to a frame system in another partially folded position, with the frame system attached to the bed of a pickup truck, according to the present invention;

FIG. 24 is a enlarged perspective view of a bi-fold hinge connected to a frame system in yet another partially folded position, with the frame system attached to the bed of a pickup truck, according to the present invention; and

FIG. 25 is an enlarged perspective view of a bi-fold hinge connected to a frame system in a folded position, with the frame system attached to the bed of a pickup truck, according to the present invention.

### DETAILED DESCRIPTION OF THE PREFERRED EMBODIMENTS

The following description of the preferred embodiment(s) is merely exemplary in nature and is in no way intended to limit the invention, its application, or uses.

A frame system used with a soft tonneau cover is shown in the Figures generally at 10. The system 10 includes a front frame assembly 12 pivotally attached to a rear frame assembly 14 through the use of a first bi-fold hinge 16. The frame assemblies 12,14 are attached to a vehicle to work in conjunction with a storage area of a vehicle, such as a pickup bed, generally shown at 18. The bed 18 includes sidewalls 20 and a front wall 22. The system 10 also includes a base frame 24 attached to the bed 18, upon which the frame assemblies 12,14 are mounted. The front frame assembly 12 has a pair of front side rails 26 connected to a front cross rail 28, and the rear frame assembly 14 includes a pair of rear side rails 30 and a rear cross rail 32. The rear frame assembly 14 is selectively connected to the base frame 24, the function of which will be described later.

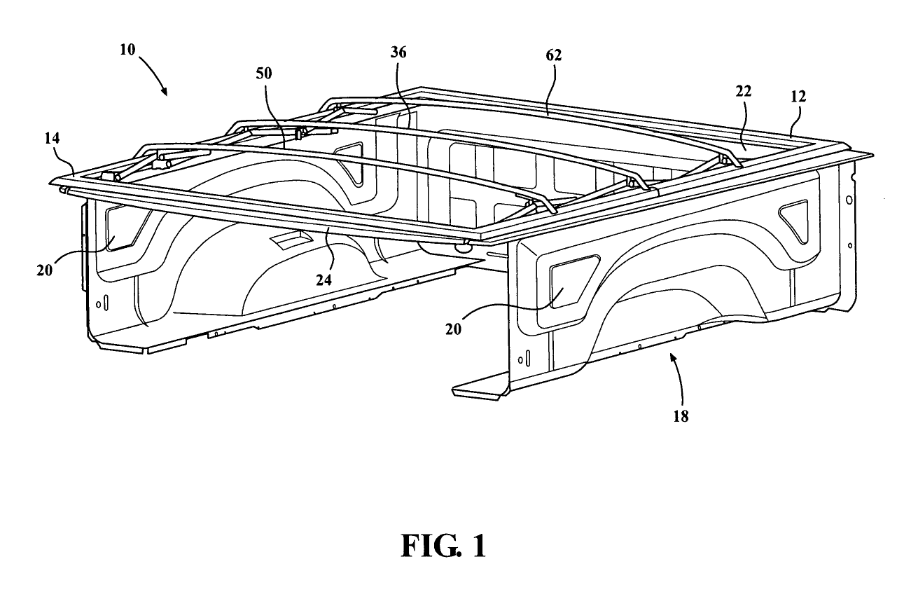

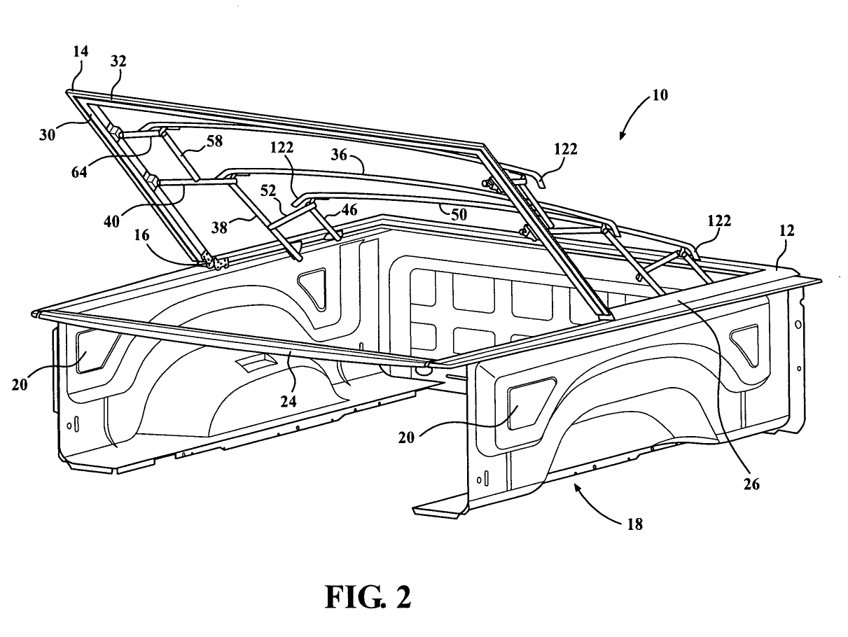

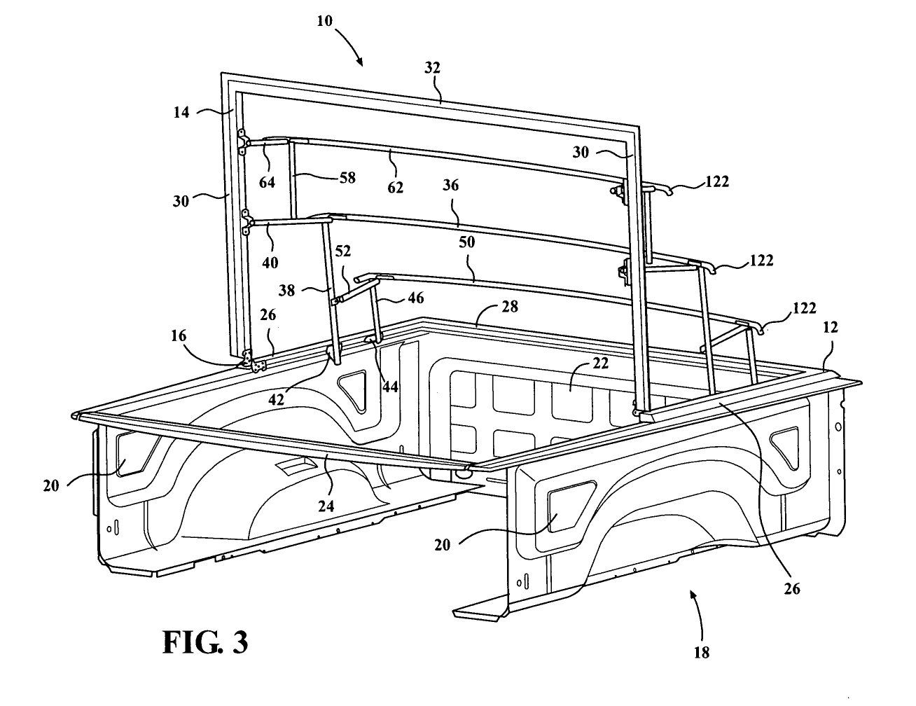

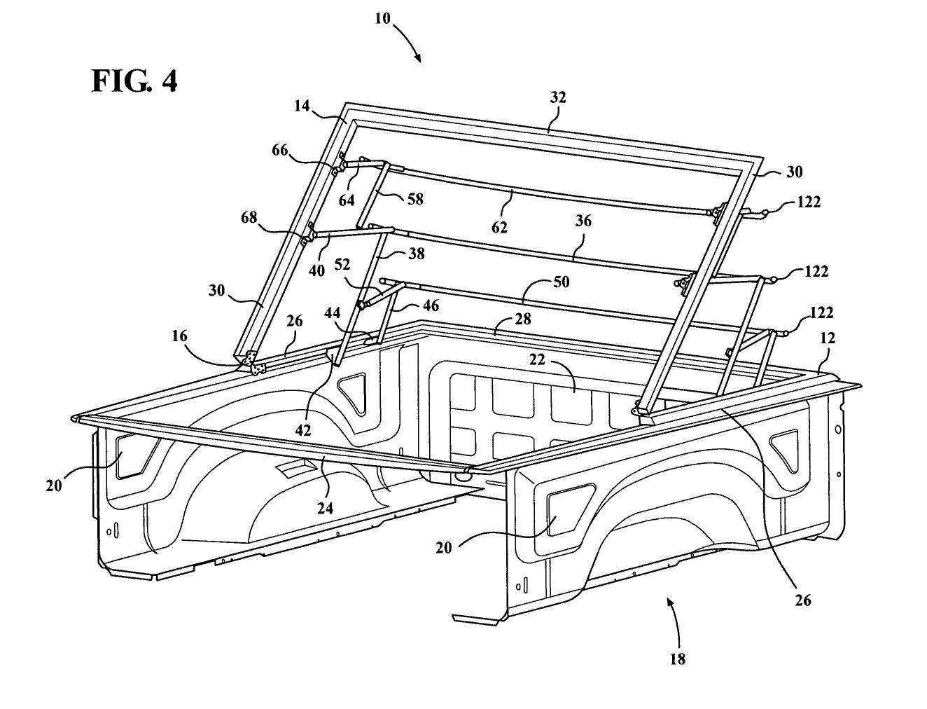

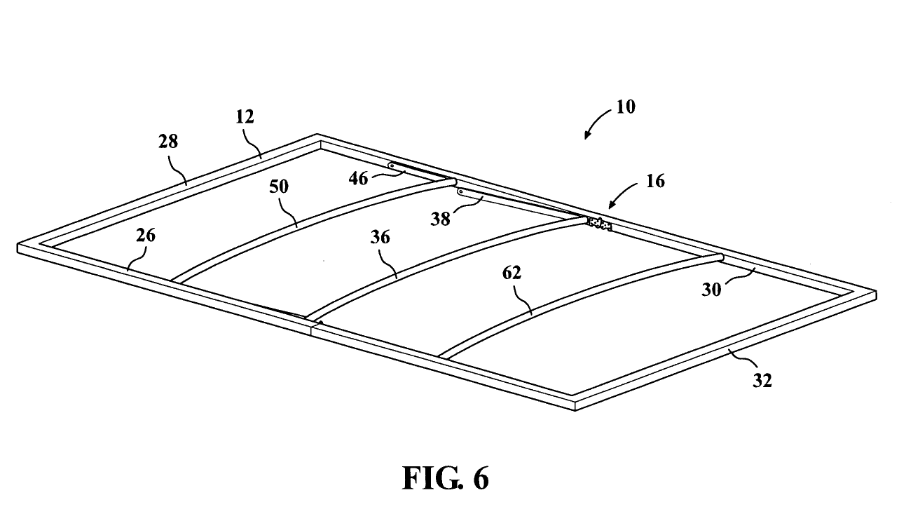

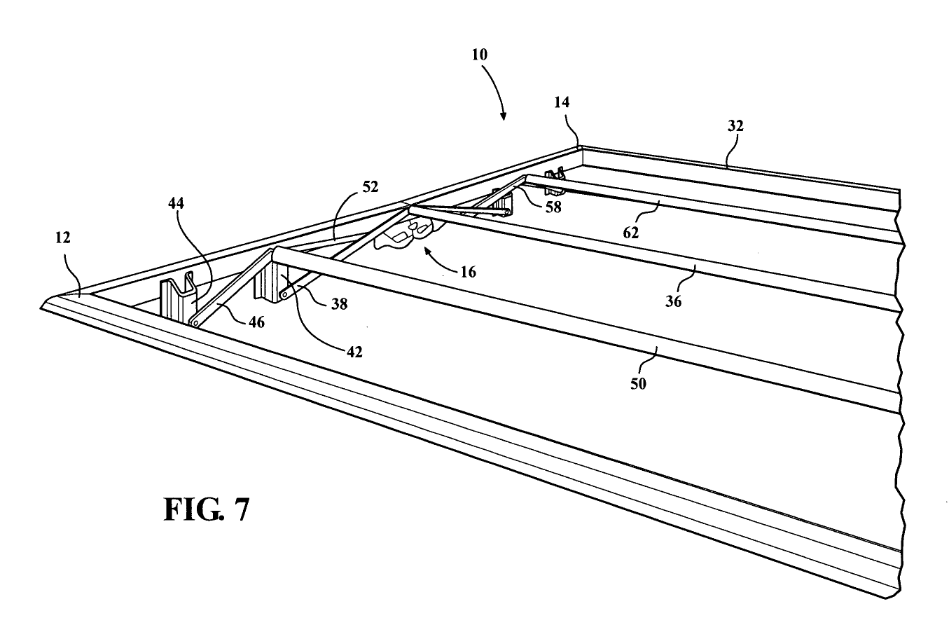

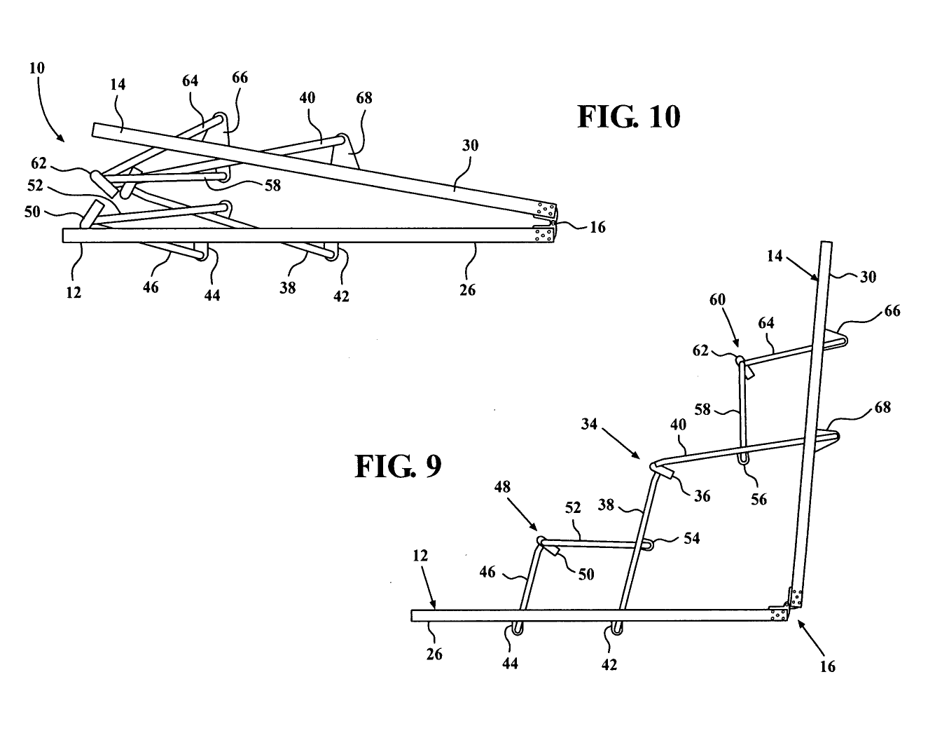

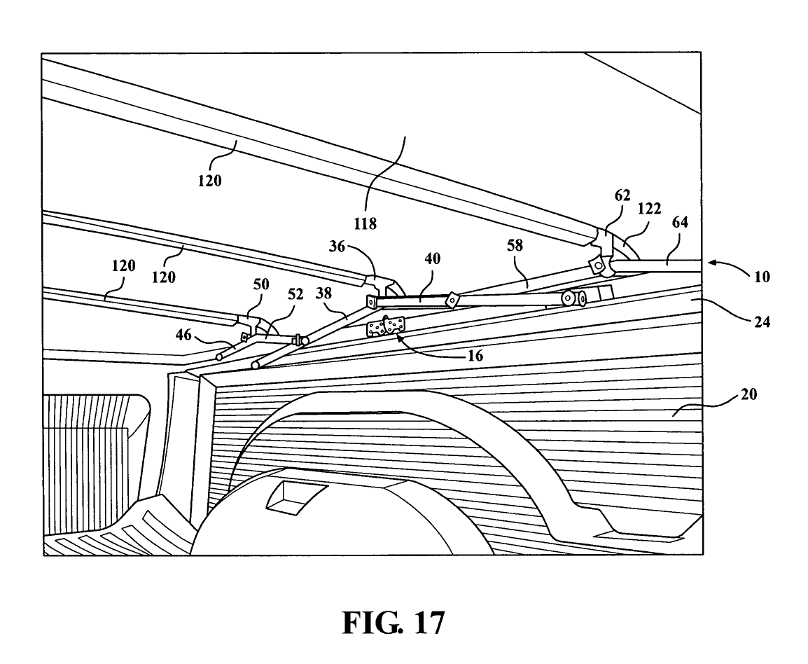

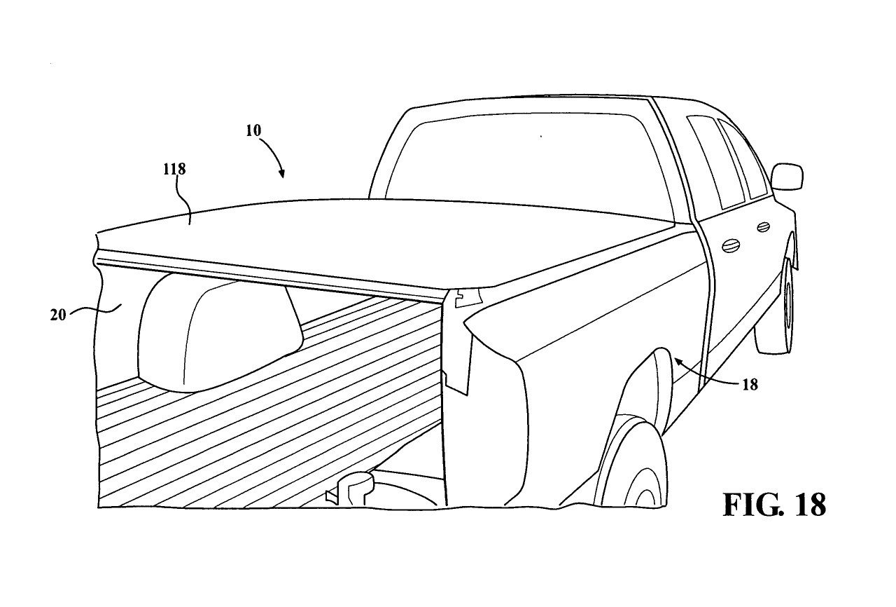

Pivotally attached to both the front and rear frame assemblies 12,14 is a middle support member or bow portion, generally shown at 34. The middle bow portion 34 includes a middle cross bow 36 extending across the bed 18 between the side walls 20 as shown in FIGS. 1-11 and 17. The middle bow portion 34 also includes two first intermediate links 38 pivotally connected to the middle bow portion 34, and two second intermediate links 40, which are also pivotally connected to the middle bow portion 34. The first intermediate links 38 are connected to a set of first front pivoting flanges 42, and the first front pivoting flanges 42 are connected to the front frame assembly 12.

There are also second front pivoting flanges 44 which are used for connecting a set of first forward links 46 to the front frame assembly 12. The first forward links 46 are part of a front support member or bow portion, generally shown at 48. The front bow portion 48 also includes a front cross bow 50 extending across the bed 18 between the side walls 20, similar to the middle cross bow 36. The first forward links 46 are pivotally connected to the front cross bow 50, and there is also a set of second forward links 52, which are also pivotally connected to the front cross bow 50. The second forward links 52 are pivotally connected to the first intermediate links 38 through the use of a set of first intermediate pivoting flanges 54.

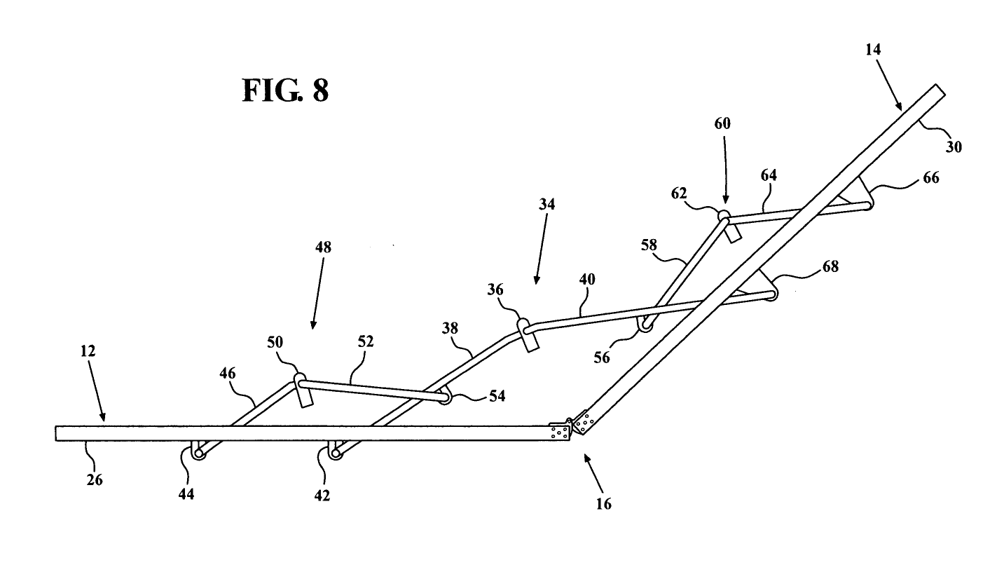

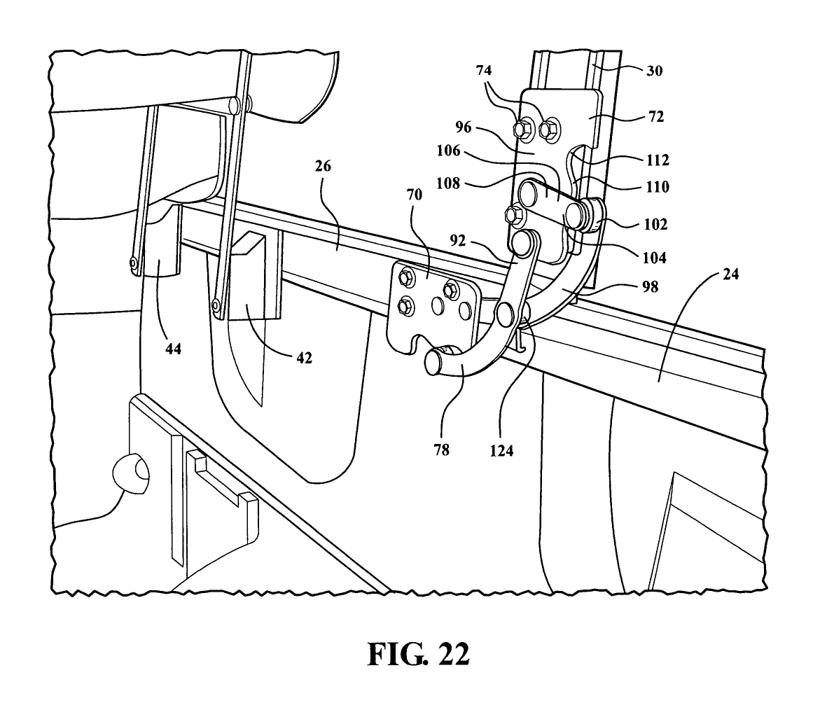

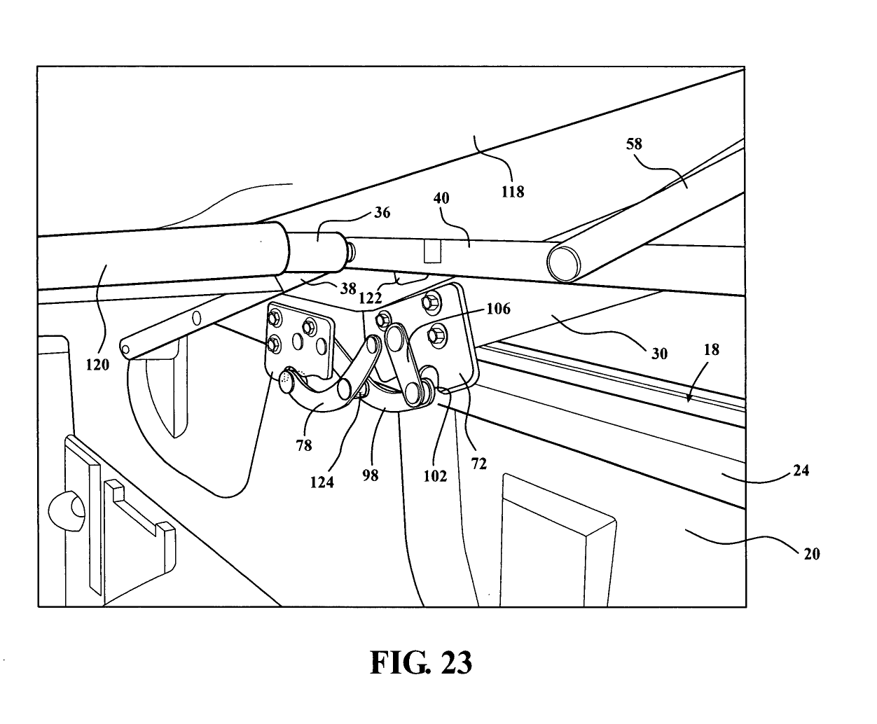

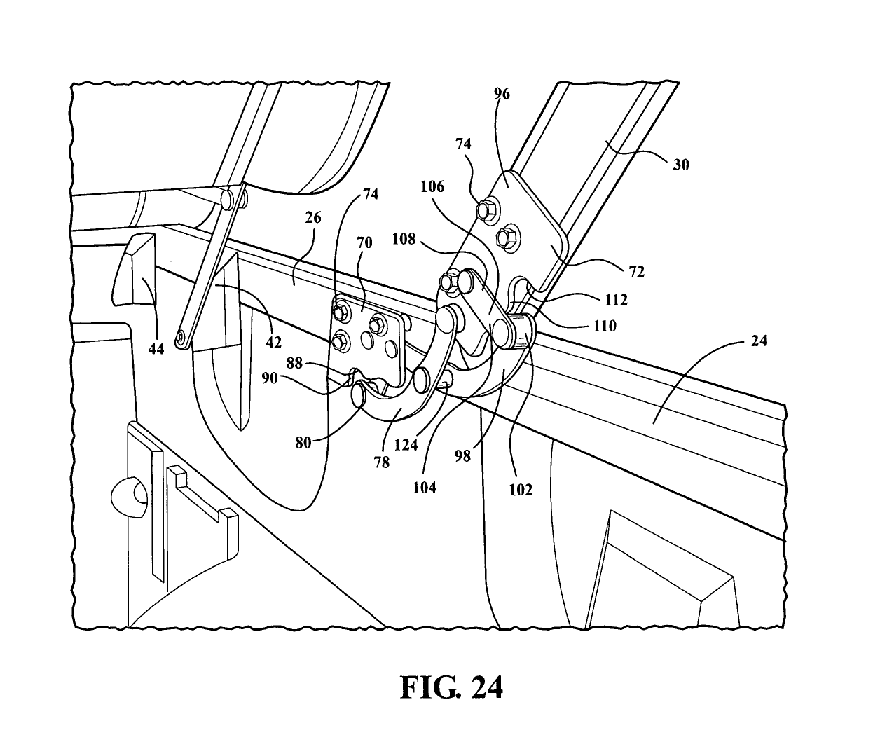

There are also second intermediate pivoting flanges 56 connected to the second intermediate links 40, and there is a set of first rearward links 58 also pivotally connected to the second intermediate pivoting flanges 56 for providing a pivot relationship between the first rearward links 58 and the second intermediate links 40. The first rearward links 58 are part of a rear support member or bow portion, generally shown at 60. The rear bow portion 60 also has a rear cross bow 62, which in a similar manner to the middle cross bow 36 and the front cross bow 50 also extends across the bed 18 between the side walls 20. The rear bow portion 60 also includes a set of second rearward links 64, which are connected to first rear pivoting flanges 66, with the first rear pivoting flanges 66 being connected to the rear frame assembly 14 as shown in FIGS. 8-10 and 22-25, thereby providing a pivoting relationship between the second rearward links 64 and the rear frame assembly 14. There are also a set of second rear pivoting flanges 68 connected to the rear frame assembly 14 and pivotally connected to the second intermediate links 40 for allowing the second intermediate links 40 to pivot relative to the rear frame assembly 14.

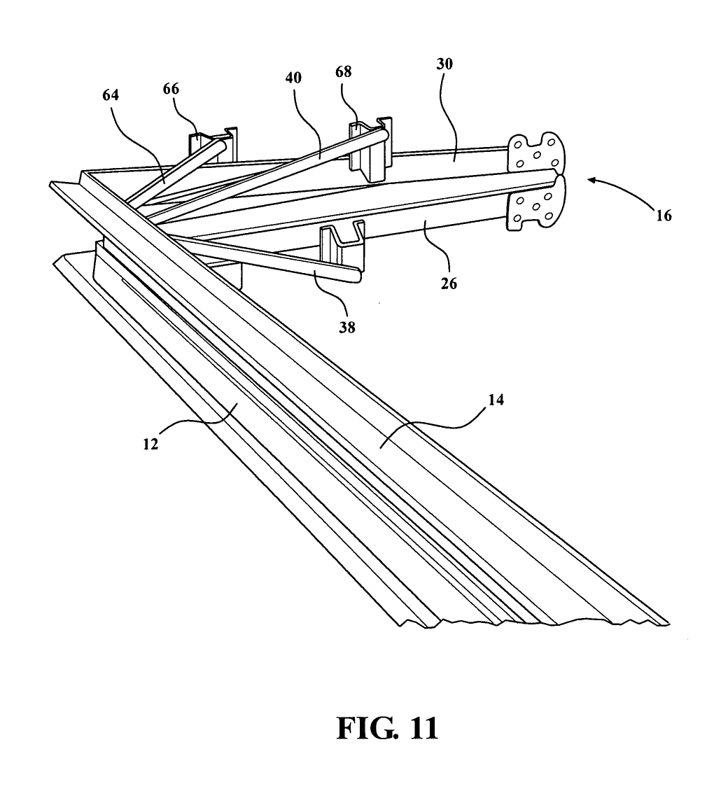

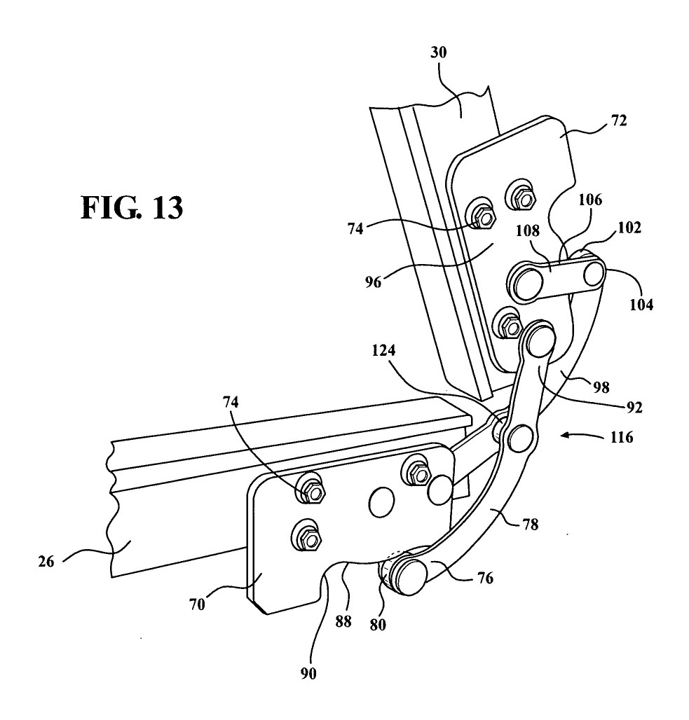

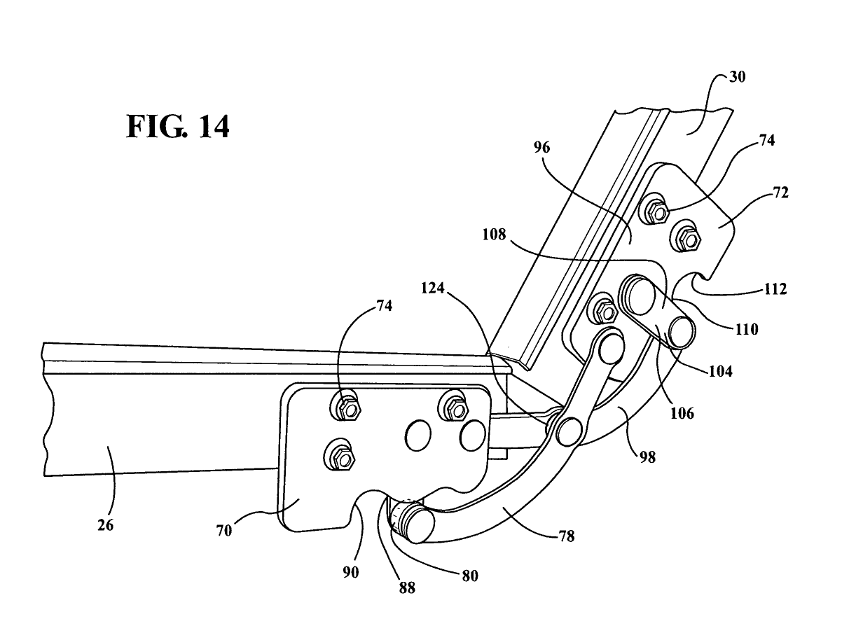

As mentioned above, there is a bi-fold hinge 16 used to pivotally attach the front frame assembly 12 to the rear frame assembly 14. However, in this embodiment, there are two bi-fold hinges 16, as shown in the Figures. Referring now to FIGS. 11-15, each hinge 16 includes a first or front base plate 70 connected to the front side rail 26 and a second or rear base plate 72 connected to the rear side rail 30. Each of the base plates 70,72 is connected to the respective rails 26,30 through a plurality of fasteners 74.

A first end 76 of a first arcuate bracket 78 is pivotally connected to a first roller 80, and the first roller 80 is pivotally connected to a first end 82 of a first pivot bracket 84, the second end 86 of the first pivot bracket 84 is pivotally connected to the front base plate 70. When the front frame assembly 12 pivots relative to the rear frame assembly 14, the first roller 80 rolls along a first contact surface 88 and selectively moves into a first recess 90. The second end 92 of the first arcuate bracket 78 is pivotally connected to the rear base plate 72. The second end 86 of the first pivot bracket 84 is connected to the front base plate 70 on the inner surface 94 of the front base plate 70, and the second end 92 of the first arcuate bracket 78 is connected to the outer surface 96 of the rear base plate 72. Because the first arcuate bracket 78 is connected to the outer surface 96 of the rear base plate 72 and the first pivot bracket 84 is connected to the inner surface 94 of the front base plate 70, the first arcuate bracket 78 and the first pivot bracket 84 are offset from one another, thereby creating a space, or gap, in between the first arcuate bracket 78 and the first pivot bracket 84. This space is compensated for by the width of the first roller 80, allowing for the first arcuate bracket 78 and the first pivot bracket 84 to be substantially parallel to each other and the base plates 70,72.

A second arcuate bracket 98 has a first end 100 pivotally attached to a second roller 102, and the second roller 102 is pivotally connected to a first end 104 of a second pivot bracket 106, a second end 108 of the second pivot bracket 106 is pivotally connected to the rear base plate 72 on the outer surface 96 of the rear base plate 72. When the front frame assembly 12 pivots relative to the rear frame assembly 14, the second roller 102 rolls along a second contact surface 110 and selectively moves into a second recess 112. The second end 114 of the second arcuate bracket 98 is pivotally connected to the inner surface 94 of the front base plate 70. Because the second arcuate bracket 98 is pivotally connected to the inner surface 94 of the front base plate 70, and the second pivot bracket 106 is pivotally connected to the outer surface 96 of the rear base plate 72, the second arcuate bracket 98 and the second pivot bracket 106 are offset from one another, thereby creating a space, or gap, in between the second arcuate bracket 98 and the second pivot bracket 106. This space is compensated for by the width of the second roller 102, allowing for the second arcuate bracket 98 and the second pivot bracket 106 to be substantially parallel to each other and the base plates 70,72.

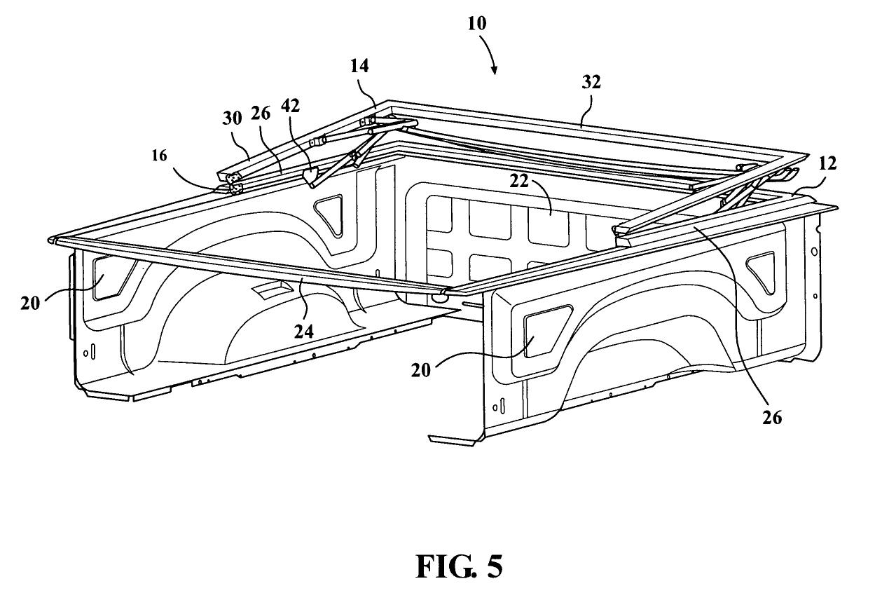

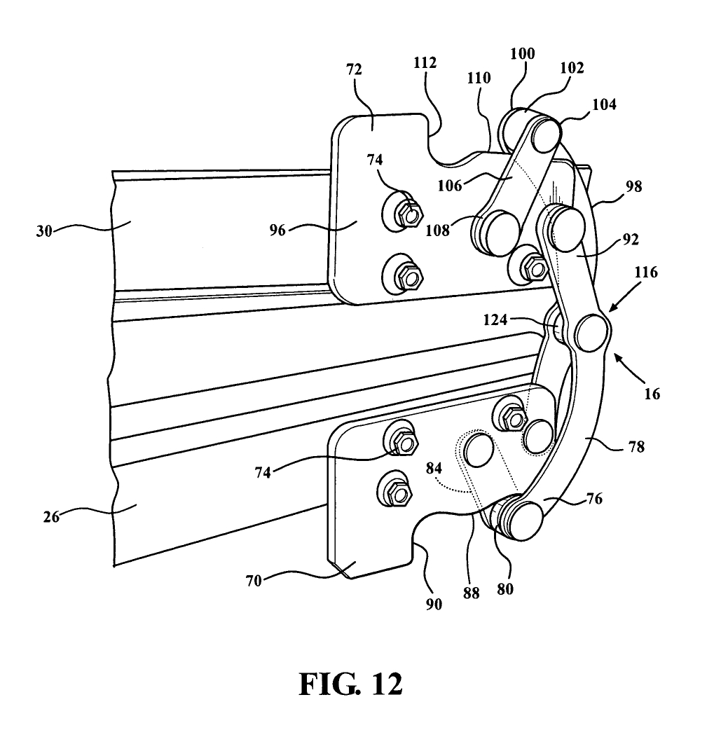

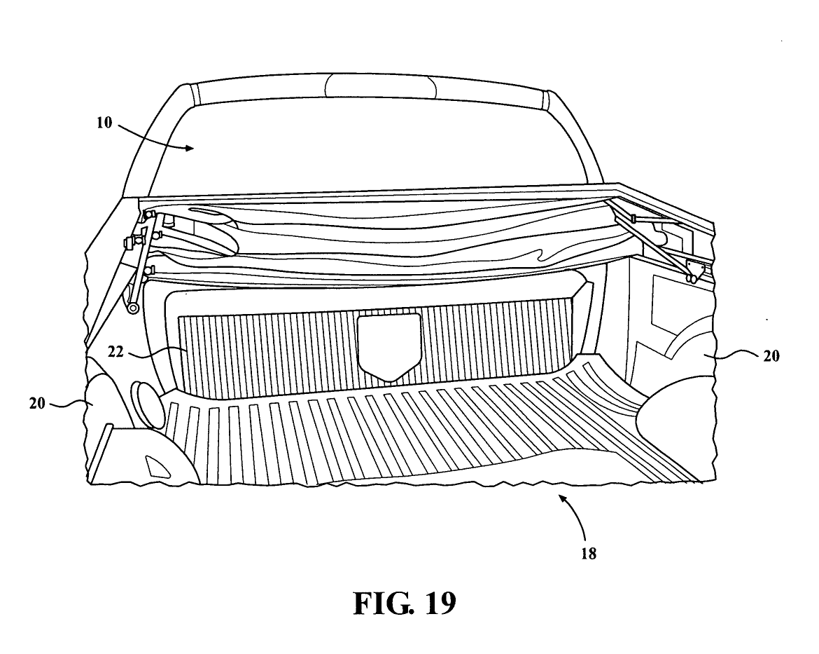

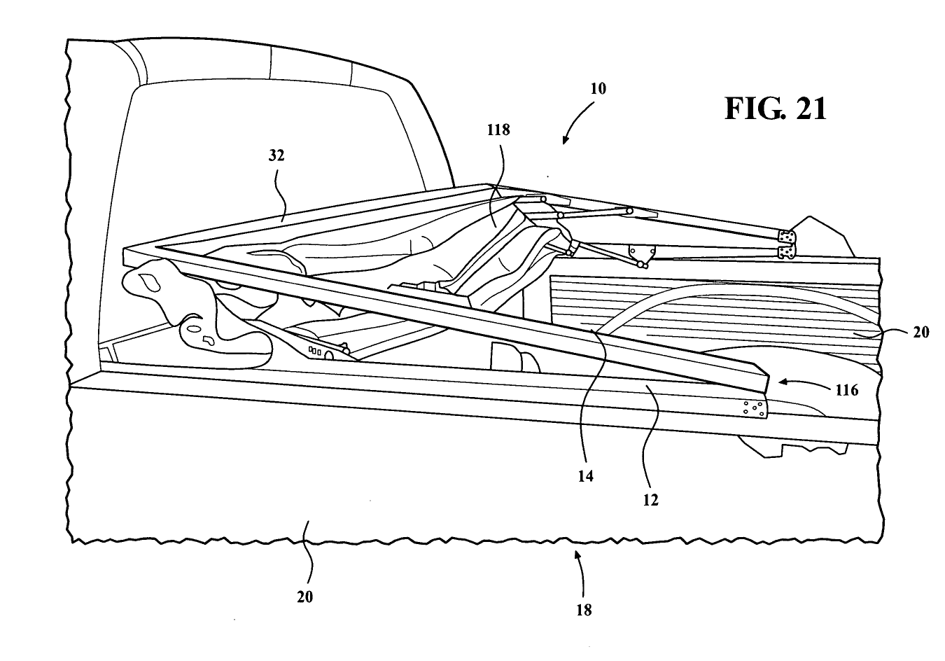

The first arcuate bracket 78 is pivotally connected to the second arcuate bracket 98 at a central pivot point 116, which functions as a “theoretical center.” The term theoretical center is used because the central pivot point 116 functions as the center of the hinge 16, but is moveable as the front frame assembly 12 and rear frame assembly 14 are pivoted relative to one another. The central pivot point 116 also includes a spacer 124 disposed between the brackets 78,98. The spacer 124 is in substantial alignment with both the front base plate 70 and the rear base plate 72. As mentioned above, the first arcuate bracket 78 is connected to the outer surface 96 of the rear base plate 72 and the second arcuate bracket 98 is pivotally connected to the inner surface 94 of the front base plate 70. This connection positions the brackets 78,98 such that they are offset from one another, and creates a spacing between the brackets 78,98; the spacer 124 is of a width to compensate for this spacing, best seen in FIGS. 12-15 and 22-25. The central pivot point 116 changes from being below the frame assemblies 12,14 when the tonneau cover is in the deployed position, as shown in FIGS. 1, 6-7, and 15-18, and in between the frame assemblies 12,14 when the tonneau cover is in the stowed position, as shown in FIGS. 5, 10-12, 19-21, and 25.

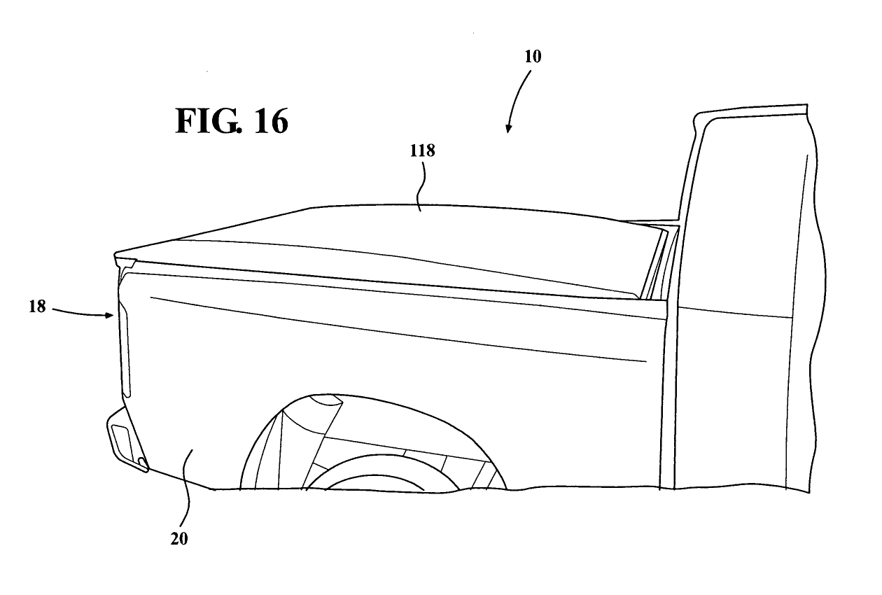

As mentioned above, the frame system 10 is used for changing a tonneau cover between a stowed position and a deployed position. A soft tonneau cover 118 is shown connected to the frame system 10 in FIGS. 16-21 and 22-25. Tension is applied to the tonneau cover 118 when the system 10 is in the deployed position by the cross bows 36,50,62. As shown in FIGS. 16-21 and 22-25, in this embodiment there are three sleeves 120 attached to the tonneau cover 118, and each of the cross bows 36,50,62 extends through a corresponding sleeve 120 but is not attached to the sleeves 120 such that each of the cross bows 36,50,62 are able to rotate in the sleeves 82. The cross bows 36,50,62 are able to rotate within the sleeves 120 to allow the system 10 to change from the stowed position to the deployed position, and vice versa.

It can also been seen when looking at the Figures that the first front pivoting flanges 42 are connected to the front side rails 26 between the bi-fold hinge 16 and the second front pivoting flanges 44. Similarly, the second rear pivoting flanges 68 are connected to the rear side rails 30 between the bi-fold hinge 16 and the first rear pivoting flanges 66.

When in the deployed position, the system 10 is shown in the position in FIGS. 1, 6-7, and 15-18. When it is desired to transport items in the bed 18 that are too large to allow the system 10 to be placed in the deployed position, the system 10 is changed from the deployed position to the stowed position in FIGS. 5, 10-12, 19-21 and 25.

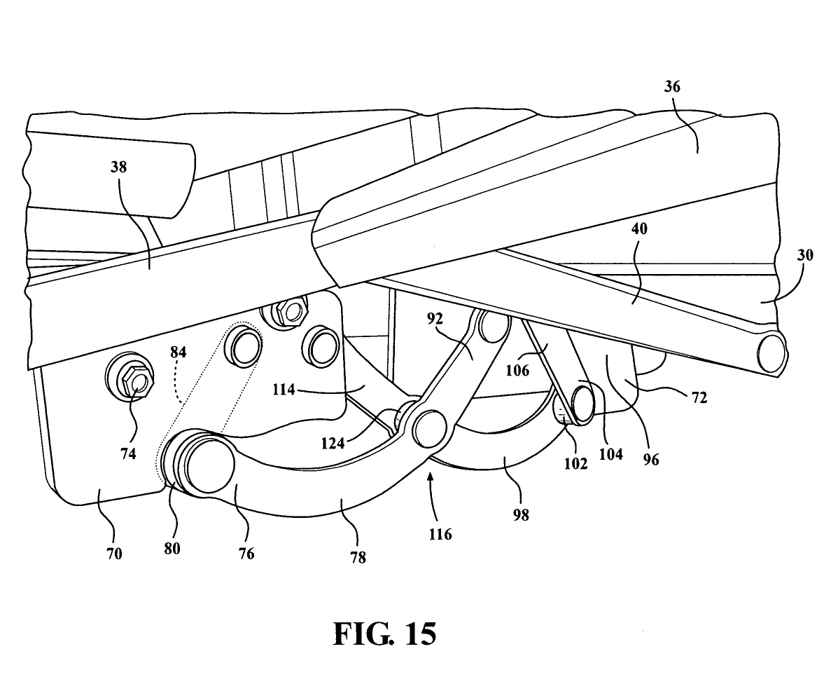

To change the position of the cable tonneau system 10, there is a pair of latches or clamps (not shown) which connect the rear frame assembly 14 to the base frame 24. The latches are released, and the rear frame assembly 14 is then pivoted relative to the front frame assembly 12. When in the deployed position, the hinges 16 are best seen in FIG. 15. In this position, the first roller 80 is disposed in the first recess 90, and the second roller 102 is disposed in the second recess 112. The recesses 90,112 limit the range of movement of the hinge 14, and therefore the frame assemblies 12,14, as the frame assemblies 12,14 are moved to the deployed position. Additionally, when in the deployed position there are horizontal forces applied to each of the rollers 80,102 by the recesses 90,112, these forces are balanced by the connection of the second end 92 of the first arcuate bracket 78 to the rear base plate 72, and the connection of the second end 114 of the second arcuate bracket 98 to the front base plate 70, as well as the central pivot point 116.

As the rear frame assembly 14 is pivoted relative to the front frame assembly 12, the connection between the first arcuate bracket 78 and the rear base plate 72 pulls the first roller 80 out of the first recess 90, and the connection between the second arcuate bracket 98 and the front base plate 70 pulls the second roller 102 out of the second recess 112. As this occurs, the first roller 80 moves along the first contact surface 88, and the second roller 102 moves along the second contact surface 110. The contact surfaces 88,110 provide a predetermined path of movement for the respective brackets 78,98 and rollers 80,102. Additionally, the first arcuate bracket 78 pivots relative to the rear base plate 72, the second arcuate bracket 98 pivots relative to the front base plate 70, the first pivot bracket 84 pivots relative to both the front base plate 70 and first arcuate bracket 78, and the second pivot bracket 106 pivots relative to both the rear base plate 72 and the second arcuate bracket 98. The first arcuate bracket 78 and the second arcuate bracket 98 also pivot relative to one another about the central pivot point 116.

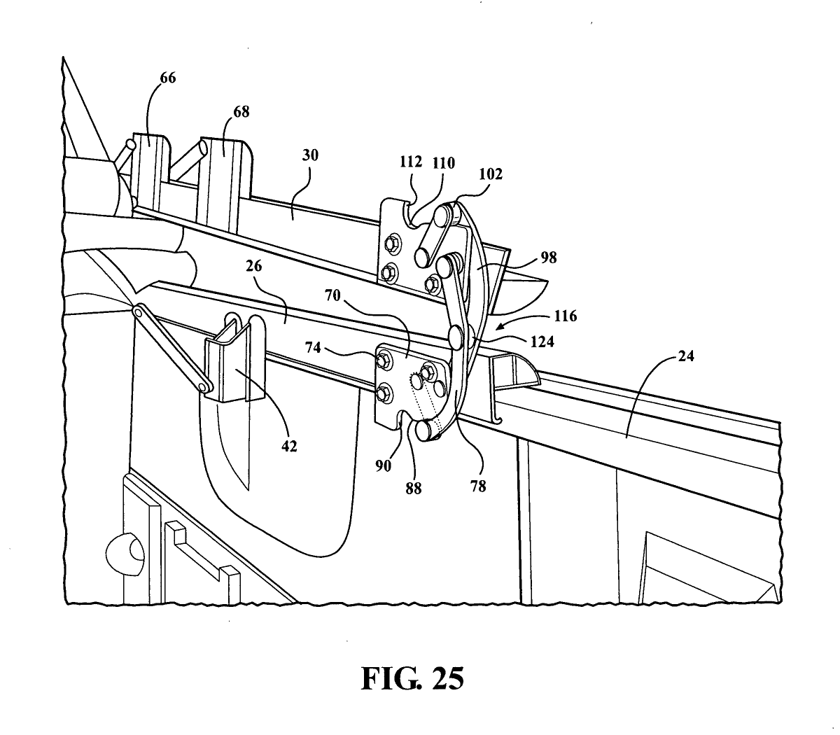

It is shown in FIGS. 12-14 and 22-25 that as the arcuate brackets 78,98 and the pivot brackets 84,106 pivot relative to one another as described above, the central pivot point 116 moves from a position below each of the frame assemblies 12,14 best seen in FIG. 15, to a position where the central pivot point 116 is above the front side rails 26, and below the rear side rails 30 when looking at FIGS. 12 and 25. The hinge 16, and more specifically the connection between the arcuate brackets 78,98, as well as the connection between the pivot brackets 84,106 and the respective base plates 70,72 functions to move the central pivot point 116 in a manner to allow the rear frame assembly 14 to be folded about one-hundred-eighty degrees such that the rear side rails 30 are able to be positioned substantially parallel relative to the front side rails 26, best seen in FIGS. 12 and 25.

All of the various links 38,40,46,52,58,64 pivot accordingly in simultaneous fashion when the rear frame assembly 14 is pivoted relative to the front frame assembly 12; since the movement of the links 38,40,46,52,58,64 is similar on both sides of the bed 18, only one side will be described.

The various positions the system 10 is operable to change to are shown in the Figures. As the rear frame assembly 14 is pivoted relative to the front frame assembly 12, the first intermediate link 38 pivots relative to the front side rail 26, and the second intermediate link 40 pivots relative to the rear side rail 30, while at the same time the first intermediate link 38 pivots relative to the second intermediate link 40. Simultaneously, this causes the second forward link 52 to pivot relative to the first intermediate link 38, the second forward link 52 and first forward link 46 to pivot relative to one another, and the first forward link 46 to pivot relative to the front side rail 26. Additionally, the first rearward link 58 pivots relative to the second intermediate link 40, the first rearward link 58 and second rearward link 64 pivot relative to one another, and the second rearward link 64 pivots relative to the rear side rail 30.

As the various links 38,40,46,52,58,64 pivot relative to one another, the cross bows 36,50,62 lift off of the respective side rails 26,30. The cover 118 is made from a substantially flexible material that is connected to the front cross rail 28 and the rear cross rail 32, and the cross bows 36,50,62 extend through the sleeves 120 as described above. The cover 118 is shaped to substantially match the shape of the bed 18, as shown in FIGS. 16-18, and may be connected to the frame assemblies 12,14 in any number of ways suitable for changing the tonneau cover 118 between the stowed position and the deployed position, such that the tonneau cover 118 folds as desired and is stowed efficiently. In one embodiment, the tonneau cover 118 is connected to the cross rails 28,32, and the cross bows 36,50,62 as described above, however, it is within the scope of the invention that the cover 118 may be connected to the frame assemblies 12,14 in other ways as well.

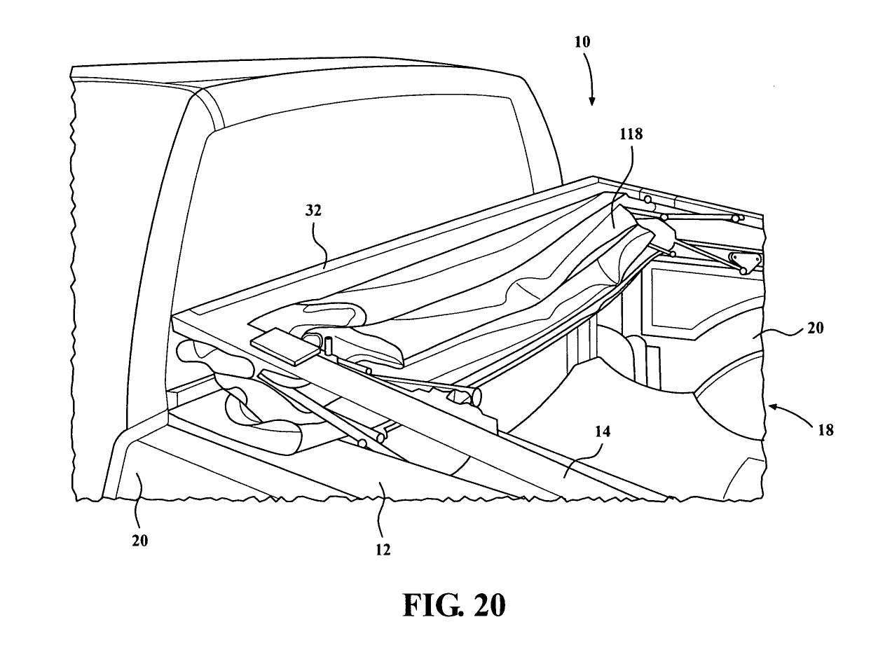

The rear frame assembly 14 is pivoted relative to the front frame assembly 12 about the hinges 16 until the system 10 is in the stowed position shown in FIGS. 5, 10-12, 19-21, and 25. As the frame assemblies 12,14 are pivoted relative to one another, the movement of the tonneau cover 118 is controlled by the position of the cross bows 36,50,62, such that the cover 118 folds in a predetermined manner when the system 10 is changed from the deployed position to the stowed position. When the rear frame assembly 14 is positioned as shown in FIGS. 19-21 and 25, the entire bed 18 is exposed for use and stowing items. Also, there are latches (not shown) which are used for locking the rear frame assembly 14 to the front frame assembly 12 when the system 10 is in the stowed position, and the bed 18 is in use.

When the system 10 is in the deployed position, the cross bows 36,50,62 contact the frame assemblies 12,14 by way of an angled end portion 122, which also provides support for the cross bows 36,50,62. The cross bows 36,50,62 also support the cover 118, and help to give the cover 118 a contoured look when the system 10 is in the deployed position. Additionally, when the system 10 is in the deployed position, the outer edges of the cover 118 extend along the side rails 26,30. Because the tonneau cover 118 is permanently affixed to the cross rails 28,32 and the cross bows 36,50,62 extend through the sleeves 120, respectively, the fabric 76 automatically spreads out to cover the bed 18 when the system 10 is in the deployed position.

The present invention provides a novel hinge 16 which is facilitates the frame assemblies 12,14 for the soft tonneau 118 cover to be flat in a deployed position, while also allowing the tonneau cover 118 to be more compact when in the stowed position. It can also be seen in the Figures that the frame assemblies 12,14 are two separate components, and the hinge 16 does not have a fixed pivot point, which further facilitates the tonneau cover 118 being opened to a flat position.

The description of the invention is merely exemplary in nature and, thus, variations that do not depart from the essence of the invention are intended to be within the scope of the invention. Such variations are not to be regarded as a departure from the spirit and scope of the invention.

1. A bi-fold hinge, comprising:
a first arcuate bracket;
a second arcuate bracket, said first arcuate bracket and said second arcuate bracket being pivotable between a stowed position and a deployed position;
a front base plate, said second arcuate bracket pivotally connected to said front base plate;
a rear base plate, said first arcuate bracket pivotally connected to said rear base plate;
a central pivot point, said first arcuate bracket and said second arcuate bracket pivotally connected to each other at said central pivot point such that said first arcuate bracket and said second arcuate bracket pivot relative to one another, said first arcuate bracket pivots relative to said rear base plate, said second arcuate bracket pivots relative to said front base plate, and said central pivot point moves as said first arcuate bracket and said second arcuate bracket are moved between said stowed position and said deployed position;
a first roller, said first arcuate bracket pivotally connected to said first roller;
a second roller, said second arcuate bracket pivotally connected to said second roller;
a first pivot bracket pivotally connected to said first roller and said front base plate such that when said first arcuate bracket and said second arcuate bracket are moved between said stowed position and said deployed position, said first pivot bracket pivots relative to said first roller and said front base plate, and said first arcuate bracket pivots relative to said first roller; and
a second pivot bracket pivotally connected to said second roller and said rear base plate such that as said first arcuate bracket and said second arcuate bracket are moved between said stowed position and said deployed position, said second pivot bracket pivots relative to said second roller and said rear base plate, and said second arcuate bracket pivots relative to said second roller.

2. (canceled)

3. The bi-fold hinge of claim 1, further comprising:
a first recess formed as part of said front base plate, said first roller operable for being selectively disposed in said first recess when said first arcuate bracket is in said deployed position; and
a second recess formed as part of said rear base plate, said second roller operable for being selectively disposed in said second recess when said second arcuate bracket is in said deployed position.

4. The bi-fold hinge of claim 3, further comprising:
a first contact surface formed as part of said front base plate in proximity to said first recess, said first roller operable for movement along said first contact surface; and
a second contact surface formed as part of said rear base plate in proximity to said second recess, said second roller operable for movement along said second contact surface;
wherein as said first arcuate bracket and said second arcuate bracket are moved between said stowed position and said deployed position, said first roller moves along said first contact surface, said second roller moves along said second contact surface, said first arcuate bracket pivots relative to said first pivot bracket, said first roller, and said rear base plate, said second arcuate bracket pivots relative to said second pivot bracket, said second roller, and said front base plate, and said first arcuate bracket pivots relative to said second arcuate bracket.

5. The bi-fold hinge of claim 1, further comprising:
a front side rail, said front base plate connected to said front side rail; and
a rear side rail, said rear base plate pivotally connected to said rear side rail, said front side rail is pivotally connected to said rear side rail with said bi-fold hinge such that when said first arcuate bracket and said second arcuate bracket are in said stowed position, said rear side rail is above and parallel to said front side rail.

6. The bi-fold hinge of claim 5, said central pivot point further comprising a theoretical center which moves as said first arcuate bracket and said second arcuate bracket are moved between said stowed position and said deployed position, such that said theoretical center is below both of said front side rail and said rear side rail when said first arcuate bracket and said second arcuate bracket are in said deployed position, and said theoretical center is above said front side rail and below said rear side rail when said first arcuate bracket and said second arcuate bracket are in said stowed position.

7. The bi-fold hinge of claim 5, wherein said front side rail and said rear side rail are part of a frame assembly operable for being mounted to the bed of a pickup truck.

8. The bi-fold hinge of claim 1, wherein said bi-fold hinge is for use with a tonneau cover operable for movement between said stowed position and said deployed position.

9. A bi-fold hinge for use with a tonneau cover, comprising:
a front base plate;
a rear base plate;
a first arcuate bracket pivotally connected to said rear base plate;
a second arcuate bracket pivotally connected to said front base plate;
a first pivot bracket pivotally connected to said front base plate and said first arcuate bracket such that said first arcuate bracket and said first pivot bracket are operable facilitating the movement of said tonneau cover between a stowed position and a deployed position;
a second pivot bracket pivotally connected to said rear base plate and said second arcuate bracket such that said second arcuate bracket and said second pivot bracket are operable for facilitating the movement of said tonneau cover between said stowed position and said deployed position;
a first roller for providing a pivot connection between said first arcuate bracket and said first pivot bracket, said first roller in rolling contact with said front base plate such that said first roller moves along a first contact surface formed as part of said front base plate when said tonneau cover is moved between said stowed position and said deployed position; and
a second roller for providing a pivot connection between said second arcuate bracket and said second pivot bracket, said second roller in rolling contact with said rear base plate such that said second roller moves along a second contact surface formed as part of said second base plate when said tonneau cover is moved between said stowed position and said deployed position.

10. (canceled)

11. The bi-fold hinge for use with a tonneau cover of claim 9, further comprising:
a first recess formed as part of said front base plate in proximity to said first contact surface; and
a second recess formed as part of said rear base plate in proximity to said second contact surface, said first roller operable for moving into said first recess and said second roller operable for moving into said second recess when said tonneau cover is in said deployed position.

12. The bi-fold hinge for use with a tonneau cover of claim 9, further comprising:
a front side rail operable for supporting said tonneau cover, said front base plate connected to said front side rail; and
a rear side rail operable for supporting said tonneau cover, said rear base plate connected to said rear side rail such that when said tonneau cover is in said stowed position, said rear side rail is located above and is substantially parallel to said front side rail.

13. The bi-fold hinge for use with a tonneau cover of claim 12, further comprising a central pivot point, wherein said first arcuate bracket and said second arcuate bracket are connected at said central pivot point, and said central pivot point is located below both of said front side rail and said rear side rail when said tonneau cover is in said deployed position, and said central pivot point is located above said front side rail and below said rear side rail when said tonneau cover is in said stowed position.

14. The bi-fold hinge for use with a tonneau cover of claim 13, said central pivot point further comprising a spacer disposed between said first arcuate bracket and said second arcuate bracket, said spacer operable for positioning said first arcuate bracket and said second arcuate bracket to be parallel to one another and to both of said front base plate and said rear base plate.

15. A bi-fold hinge for use with a tonneau cover, comprising:
a first arcuate bracket pivotally connected to a first roller;
a second arcuate bracket pivotally connected to a second roller;
a front base plate mounted to a front side rail, said second arcuate bracket pivotally connected to said front base plate;
a first recess formed as part of said front base plate, said first roller operable for being selectively disposed in said first recess;
a first contact surface formed as part of said front base plate in proximity to said first recess, said first roller operable for movement along said first contact surface;
a rear base plate mounted to a rear side rail, said first arcuate bracket pivotally connected to said rear base plate;
a second recess formed as part of said rear base plate, said second roller operable for being selectively disposed in said second recess;
a second contact surface formed as part of said rear base plate in proximity to said second recess, said second roller operable for movement along said second contact surface;
a first pivot bracket pivotally connected to said first roller and said front base plate;
a second pivot bracket pivotally connected to said second roller and said rear base plate; and
a central pivot point, said first arcuate bracket and said second arcuate bracket pivotally connected to each other at said central pivot point;
wherein as said tonneau cover is moved between a stowed position and a deployed position, said first roller moves along said first contact surface, said second roller moves along said second contact surface, said first arcuate bracket pivots relative to said first pivot bracket, said first roller, and said rear base plate, said second arcuate bracket pivots relative to said second pivot bracket, said second roller, and said front base plate, and said first arcuate bracket pivots relative to said second arcuate bracket.

16. The bi-fold hinge for use with a tonneau cover of claim 15, further comprising a spacer pivotally connected to both said first arcuate bracket and said second arcuate bracket for positioning said first arcuate bracket and said second arcuate bracket to be parallel to one another and both of said front base plate and said rear base plate.

17. The bi-fold hinge for use with a tonneau cover of claim 15, further comprising said first roller is disposed in said first recess and said second roller is disposed in said second recess when said tonneau cover is in said deployed position.

18. The bi-fold hinge for use with a tonneau cover of claim 15, wherein said tonneau cover is connected to said front side rail and said rear side rail, and when said tonneau cover is in said deployed position, said front side rail is substantially parallel to said rear side rail.

19. The bi-fold hinge for use with a tonneau cover of claim 18, said central pivot point further comprising a theoretical center which moves as said tonneau cover is moved between said stowed position and said deployed position, such that said theoretical center is below said front side rail and said rear side rail when said tonneau cover is in said deployed position, and is above said front side rail and below said rear side rail when said tonneau cover is in said stowed position.

20. A bi-fold hinge for use with a tonneau cover, comprising:
a front base plate;
a rear base plate;
a first arcuate bracket pivotally connected to said rear base plate;
a second arcuate bracket pivotally connected to said front base plate;
a first pivot bracket pivotally connected to said front base plate and said first arcuate bracket such that said first arcuate bracket and said first pivot bracket are operable facilitating the movement of said tonneau cover between a stowed position and a deployed position;
a second pivot bracket pivotally connected to said rear base plate and said second arcuate bracket such that said second arcuate bracket and said second pivot bracket are operable for facilitating the movement of said tonneau cover between said stowed position and said deployed position;
a first recess formed as part of said front base plate in proximity to said first contact surface; and
a second recess formed as part of said rear base plate in proximity to said second contact surface, said first roller operable for moving into said first recess and said second roller operable for moving into said second recess when said tonneau cover is in said deployed position.

21. The bi-fold hinge for use with a tonneau cover of claim 20, further comprising:
a front side rail operable for supporting said tonneau cover, said front base plate connected to said front side rail; and
a rear side rail operable for supporting said tonneau cover, said rear base plate connected to said rear side rail such that when said tonneau cover is in said stowed position, said rear side rail is located above and is substantially parallel to said front side rail.

22. The bi-fold hinge for use with a tonneau cover of claim 21, further comprising a central pivot point, wherein said first arcuate bracket and said second arcuate bracket are connected at said central pivot point, and said central pivot point is located below both of said front side rail and said rear side rail when said tonneau cover is in said deployed position, and said central pivot point is located above said front side rail and below said rear side rail when said tonneau cover is in said stowed position.

23. The bi-fold hinge for use with a tonneau cover of claim 22, said central pivot point further comprising a spacer disposed between said first arcuate bracket and said second arcuate bracket, said spacer operable for positioning said first arcuate bracket and said second arcuate bracket to be parallel to one another and to both of said front base plate and said rear base plate.
